(19) United States
(12) Patent Application Publication
(10) Pub. No.: US 2004/0099159 A1
(43) Pub. Date: May 27, 2004

(54) Apparatus for printing objects of the tablet type, in particular medical tablets and process therefor

(76) Inventor: Laurent De Volder, Maria-Aalter (BE)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/718,144

(22) Filed: Nov. 20, 2003

Related U.S. Application Data
(63) Continuation of application No. 10/101,895, filed on Mar. 20, 2002, now abandoned.
Application No. 10/101,895 is a continuation of application No. PCT/BE00/00110, filed on Sep. 21, 2000.

(30) Foreign Application Priority Data
Sep. 21, 1999 (BE) 9900630

(51) Int. Cl. B41F 17/00

(52) U.S. Cl. 101/35

(57) ABSTRACT

Printing apparatus for printing relatively small light objects having a certain fragility and/or porosity, in particular of the tablet type, more particularly medical tablets (6), comprising a movable print head (25), a printing liquid tank (30), and a conveyor unit (32) supplying and discharging the objects to be printed (6) to, respectively from the print head (25), remarkable in that the print head (25) is arranged in a linear pad printing system a closed ink system with wherein said printing liquid tank (30) is arranged, wherein said conveyor unit (32) is comprised of a rotating table (14, 17) having predetermined locations, (24; respectively 24′, 24″) which are intended for receiving temporarily the objects (6) during the printing stage and process therefor.

### CROSS REFERENCE TO RELATED APPLICATIONS

This application is a continuation of U.S. patent application Ser. No. 10/101,895, filed Mar. 20, 2002, which is a continuation of International Application No. PCT/BE00/00110, filed Sep. 21, 2000, which claims priority of Belgian Patent Application No. 9900630, filed Sep. 21, 1999.

### BACKGROUND OF THE INVENTION

This invention relates to an apparatus and a process for printing objects of the tablet type, in particular medical tablets.

Printing of medical tablets with the name of a trademark, a logogram or any type indication is performed more and more the past few years. The pharmaceutical companies wish to distinguish themselves from the so-called generic drug producers. These generic drugs contain often the same active materials as the original drug, but they are much cheaper. A few years ago, this marking was carried out by means of a so-called embossing process, wherein an image is pressed into the tablets when pressing the tablets by means of a relief stamp. Owing to the fact that said marking does not show any difference of colours with respect to the tablet itself, and thus no contrast, this way of marking is visually not efficient. In addition, the costs of the relief stamps and changing and adjusting them is considerable. Therefore, said embossing technique is replaced by printing with ink which must be definitely edible.

They are several possibilities for printing a medical tablet with ink being approved for medical purposes. The presently far most used technique is the rotary pad printing. In rotary pad printing, a rotating cylinder 1 is used wherein the images to be printed are engraved. The cylinder is arranged horizontally and the bottom side turns around in an ink cup 2. The ink is scraped off from the cylinder by means of a scraping knife 3 in such a way that ink remains only in the engravings. A pad 4 covered with rubber, generally silicon rubber, runs against said cylinder and takes the remaining ink, and thus the image to be printed, over from the cylinder.

The pad with the images then runs over the tablets on which the image is deposited. This printing process requires an accurate synchronisation of the rotary printing pad, i.e. the pad and the clich cylinder, and the tablets to be printed which pass through a conveyor system in a determined direction 7.

Some important drawbacks are connected to rotary pad printing. It involves a lower printing quality owing to differences in speed between the various parts. In order to achieve a good printing quality with rotary pad printing, it is important that the speed 10 of the tablets in the tablet conveyor system and the peripheral speed 9 of the pad have exactly the same magnitude. In case said speeds are mutually different, there will be some slip and this will affect disadvantageously the printing quality.

However, the problem consists in that most medical tablets do not have a pure cylindrical shape. The top as well as the bottom sides of the tablet are arched slightly to strongly. The flexibility of the rubber 5 of the pad solves this problem. The curve of the tablets presses the silicone layer slightly. However, owing to the fact that the angular speed 8 of the pad is constant, the peripheral speeds at the various contact points of the tablet are not equal to the linear moving speed 11 of the tablet. This brings thus always some slip that is inherently linked to the structure itself of the tablets, resulting in a worse printing quality.

Nearly the whole upper surface of the tablet can be printed when printing plane tablets 13 with rotary pad printing. In case the tablets 13′ have a curved upper and under surface, the pad 12 needs to be pressed more on the tablet, whereby it looks like the tablet is pressed partly in the silicone rubber of the pad. Depositing a printing image having a determined size on the tablet is possible only in this way.

However, in case the pressure of the pad on the tablet becomes too large, there is a risk that the tablet 13″ flies into pieces. A maximum admissible size of the printing image on the tablet is thus determined. In addition, in pad printing the thickness of the ink layer that can be deposited on the product with rotary pad printing is not so large. This may result in problems for printing porous tablets, which absorb a lot of ink. In this case, the printing does not look very contrasted. An example is printing of dark, porous tablets with white ink. In the latter case, it may occur that printing by rotary pad printing looks rather grey than white. This thus results in an impression of fading which is undesired.

There is also the risk of contamination in the conveyor system for tablets. In the pharmaceutical world, danger for contamination is considered very carefully. Contamination may occur by external pollution that gets mixed with the tablets, but also by remaining tablets from a previous production batch. Generally, the guideline prescribes that there should be the least possible hollow places, little angles and holes in the printing apparatus in order to reduce the likelihood on remaining extraneous particles.

The tablet conveyor system for rotary pad printing is generally comprised of a chain of strips with holes wherein the tablets are picked up. This chain then runs along the rotary print head, which presses the tablets on the chain.

The risk for pollution is inherent to the conveyor system for tablets having such a chain. Dust particles, broken tablet particles or even whole tablets may remain between the strips on the chain. Cleaning the tablet conveyor system between two production batches: presents the drawback that it is a very time consuming activity. In addition, there are still further risks connected to escaping solvents from the ink, thereby generating a danger for fire and explosion. The inks which are used for printing medical tablets are typically inks the solvents whereof consist in very volatile and inflammable materials, such as propane, ethanol, butane and so on.

Most of the time, the rotary pad printing systems are provided with an open ink tray. The inking of the engraved cylinder is performed by running this cylinder in a little container with ink and by scraping off the ink excess with a scraping knife. In small isolated rooms, or in rooms where the air is circulated, a typical situation for so-called medical clean rooms, there may be generated an explosive solvent air blend fairly quickly by the evaporation of the solvent from the ink. In order to avoid this, complex aspiration systems are often used, which can in turn generate problems with the printing quality again because of strong air streams around the engraved cylinder and the pad cylinder.

The evaporation of solvent from ink in an open ink system does not only result in dangerous solvent/air mixtures, but also in that the ink in the open ink container slowly loses solvent and thus becomes thicker. Owing to this change in viscosity, the pressure characteristics of the ink also change, resulting in that the printing quality decreases still more.

A solution for this consists in the use of an expensive viscosity control system which, if need be, dilutes the ink again by adding additional thinner. This leads to the need for viscosity control systems and pumps for the ink. A drawback of such a viscosity control system then consists again in the additional work produced when cleaning and the in the fact that generally more expensive ink is needed initially in order to achieve a stably working control system.

### SUMMARY OF THE INVENTION

In order to remedy to the above-mentioned drawbacks, there is provided according to the invention a linear pad printing apparatus provided with a closed ink system and a rotary table on which the tablets are conveyed in segments over a plane plate. According to the invention, there is thus proposed a printing apparatus comprising a movable print head, a printing liquid tank, and a conveying unit supplying and discharging the objects to be printed to, respectively from the print head, which is remarkable in that the print head is arranged in a linear pad printing system with a closed ink system, wherein said printing liquid tank is arranged, and wherein said conveyor unit is comprised of a rotating table on which the objects to be printed can be taken up temporarily in predetermined locations, during the printing stage.

Further features and particularities of the apparatus according to the invention are defined in the sub-claims.

Thanks to the system according to the invention, the problems that are inherent to the rotary pad printing system of the prior art described above are solved. The various advantages of the system are set out hereafter.

The reduced printing quality, which is produced by speed differences, is not present in linear pad printing because the tablets do not move during the printing operation.

In linear pad printing, the silicon or rubber part of the pad may be much softer than in rotary pad printing, without loosing printing quality. Because the pad is softer, it can also roll off much further or deeper over the tablet and it can therefore print a larger printing image on curved tablets, without any risk for damaging the tablet. This results in that the maximum printing image limitation is considerably pushed away.

In linear pad printing, a much thicker ink layer than in rotary pad printing can be deposited. This enhances the contrast and the printing quality when printing porous tablets.

The invention is much simpler to clean and therefore better protected against contamination when using an entirely plane and preferably very smooth polished table plate on which the tablets slide together with simply removable segment plates.

Indeed, removing the segments lasts some minutes after which the entire segments may be plunged in a cleaning and decontaminating bath. The smooth table surface on which the tablets slide in the segments is then totally free for being cleaned with a cloth with a decontaminating and cleaning agent, often alcohol. This too can be done in a short time.

The use of closed ink patterns as described above results in that the quantity of solvents which escapes from the ink system is very small. This results in a remarkably smaller exploding danger, in contrast to existing systems such as with an open ink system with a scraping beam. The drawback thereof is that the ink is exposed to the air over a large surface. It is necessary to have an ink circulation system that also controls automatically the viscosity of the ink. Fast yet, evaporating solvents are used so that the ink becomes unusable very quickly, typically in some ten of minutes time, without this viscosity control system. The evaporating solvents may generate dangerous conditions of fire and explosions.

The ink used in the pharmaceutical sector is thixotropy. Keeping the viscosity of the ink at the right level is thereby rendered still more difficult. When operating wrongly, the viscosity control system can become yet quickly unstable.

In order to achieve a stable viscosity control system, it is necessary to use a relatively large quantity of expensive ink in the ink system.

Due to the complex ink circulation system with viscosity control, cleaning the ink system is a fastidious and long operation. The hoses of the ink system are often thrown away after one use for saving time.

Switching over to another ink type or ink colour requires a complete second ink system and a long machine stop, typically up to approximately 40 minutes. Cleaning the first ink system is not yet calculated in these times.

For remedying thereto, closed little inkpots are advantageously used. The machine is provided with two closed little inkpots, typically approximately 200 ml each. The evaporation of the solvents in the ink is minimized owing to the fact that the little pots are closed by means of a cap. Consequently, no ink circulation system is needed, neither a viscosity control. Depending on the type of ink, the machine can work for some time typically from 3 to 18 hours, without the need of additional solvents.

Cleaning the little inkpots is very simple and fast with a minimum loss of expensive ink.

An additional advantage consists in that switching of ink type can be carried out in some minutes and merely requires a second set of little inkpots.

In order to hold the tablets during the printing cycle to prevent them from adhering to the pad, a vacuum system comprised of a vacuum chamber, referred to as a vacuum block, to which an electrical vacuum pump is connected can be used. The vacuum block is mounted right under the position where the tablets are printed. The upper side of the block has little holes that are closed by pens. Each little hole is located right in the middle under the tablet to be printed. During the printing cycle, the pens are pulled out from the little holes by means of a pneumatic cylinder, resulting in that the tablet located above them are maintained with the vacuum. After the printing operation, the pens close the little holes again so that the vacuum can recover again in the vacuum block.

Important drawbacks in connection with this consist in that this is a quite complicated and perturbation sensitive system, which was developed for one specific shape of tablets. Each time a new type of tablet must be printed, the complete vacuum block must be changed.

In addition, said vacuum block is quite expensive due to the use of precision parts, such as closing pens, a smooth stainless steel top plate, etc.

The total weight of the vacuum block is approximately 30 kg, and it must be removed manually from the middle of the machine for changing it. It is also possible to use an electrical lift, but switching to another tablet type still remains complicated.

For remedying thereto, there is provided yet according to the invention a vacuum system so as to hold the tablets during the printing operation, but by using an additional vacuum buffer and one single vacuum valve, it is possible to disregard the system with pens. It results therefrom that it is no longer necessary to change the whole vacuum block when varying the type of tablet. It is enough to merely change the stainless steel upper plate having the little holes according to a determined pattern for that type of tablet. And this is yet possible in a simple way.

Consequently, only one vacuum block is needed, which is cost saving. Switching to other types of tablets becomes faster and is performed by one single person without performing any physical effort.

The likelihood of disturbances is thus considerably smaller thanks to a simpler system. The completion of the tablet machines has thus become substantially better. Requirements existing in the pharmaceutical world are also being considered thereby.

For shorter production cycles, for example three to five hours continuously producing, it is not necessary to add solvents in between with a closed ink system. For longer production cycles, a simple system whereby a little solvent is added on a regular basis is enough. A complete automatic viscosity system is thus superfluous. In this way a simple system is achieved.

Further details of the invention are set out in the description hereafter of an exemplary embodiment of the apparatus according to the invention with the appended drawings.

### BRIEF DESCRIPTION OF THE DRAWINGS

FIGS. 1 to 5 are a diagrammatic representation of the known prior art in the case of rotary printing of tablets.

FIG. 6 is a diagrammatic representation of a tablet conveying system in an apparatus according to the invention.

FIG. 7 is a diagrammatic top view of an embodiment of a conveying system for tablets according to the preceding figure.

FIG. 8 is a diagrammatic representation of a vacuum system in the apparatus according to the invention.

FIGS. 9 and 10 are each a diagrammatic representation of the roll process in linear pad printing.

FIG. 11 show diagrammatically the different steps of the process according to the invention.

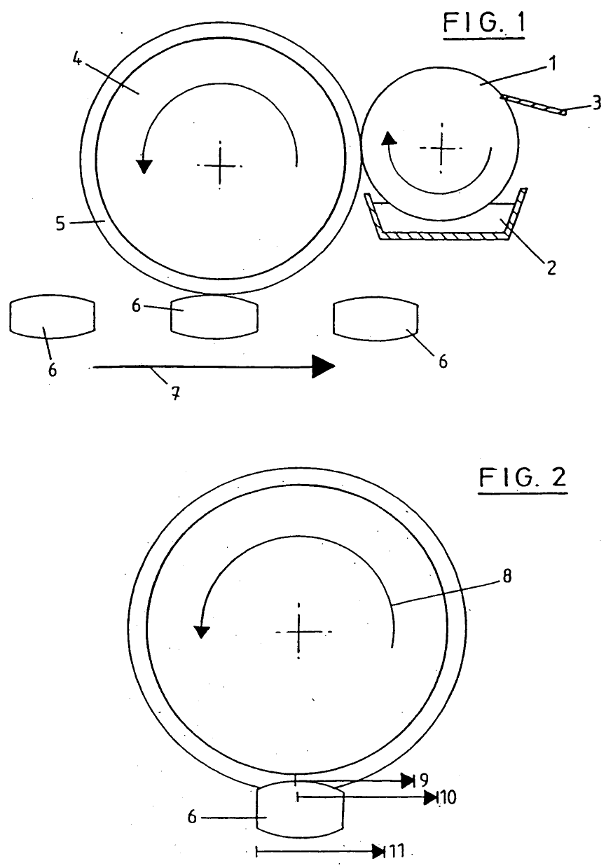

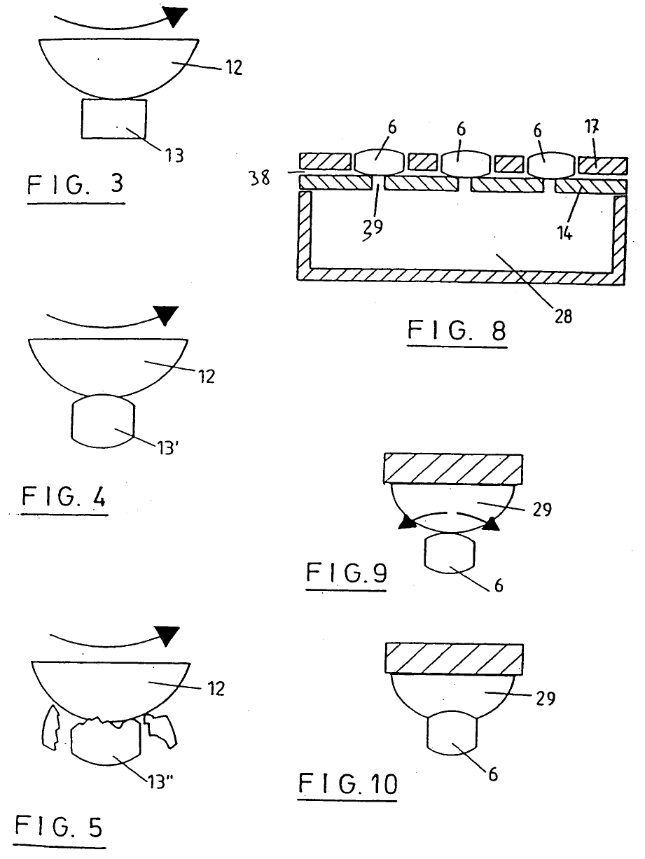

### DETAILED DESCRIPTION OF PREFERRED EMBODIMENTS

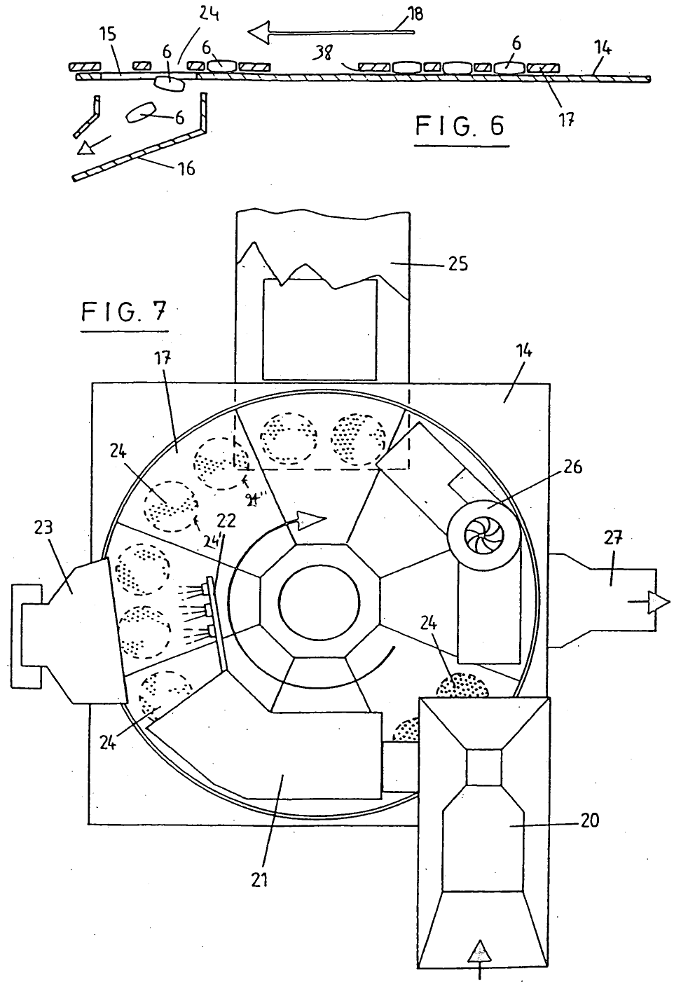

A very smooth table plate 14 is used for a conveyor system for tablets as shown in FIG. 6. Besides, the apparatus parts, and more specifically those of the conveyor system for tablets are so plane and smooth as possible, so that they can be cleaned and disinfected in a simple way. Easily removable segments 17 are mounted above this table plate, which are arranged in a floating way some tens of millimetres above the table plate 14. The segments are provided with holes 24 wherein the tablets 6 fit. By moving the segments over the table plate 18, the tablets 6 are carried away. They rest yet on the very smooth table plate 14.

Supplying the tablets in the segment holes 24 can be done in different ways. A brush casing 21 can be used in this case, wherein a brush system that is incorporated herein makes that all holes 24 in the segments 17 are occupied and filled up by a tablet 6. Evacuating the tablets takes place in a very simple manner. The tablets, which are not fixed in the holes of the segment but are only carried therewith, fall through an outlet aperture 15 in the table plate 14. Hereunder there is a drain 16 wherein the tablets 6 are received and thus evacuated from the apparatus.

An exemplary embodiment of the invention with for example eight segments is represented diagrammatically in FIG. 7. The eight segments 17 are mounted in the centre on the axis of an indexer casing. The segments 17 can be rotated one by one in the printing position by means of said indexer casing.

The segments 17 turn clockwise in an indexed way. The tablets are supplied to the brush system 21 by means of a supply bunker 20. This brush system allows the tablet holes 24 in the segments to be filled up with tablets. In this case, they are for instance two circular groups 24′, 24″ of tablets for each segment. The segments filled up with tablets rotate by passing ahead of a blow unit, such as an air knife 22, which blows waste tablets or dust in a receiving container 23 by means of compressed air. Finally, the segments rotate under the linear print head where they are printed. After passing in a drying station 26, the printed tablets are evacuated by means of a drain 27.

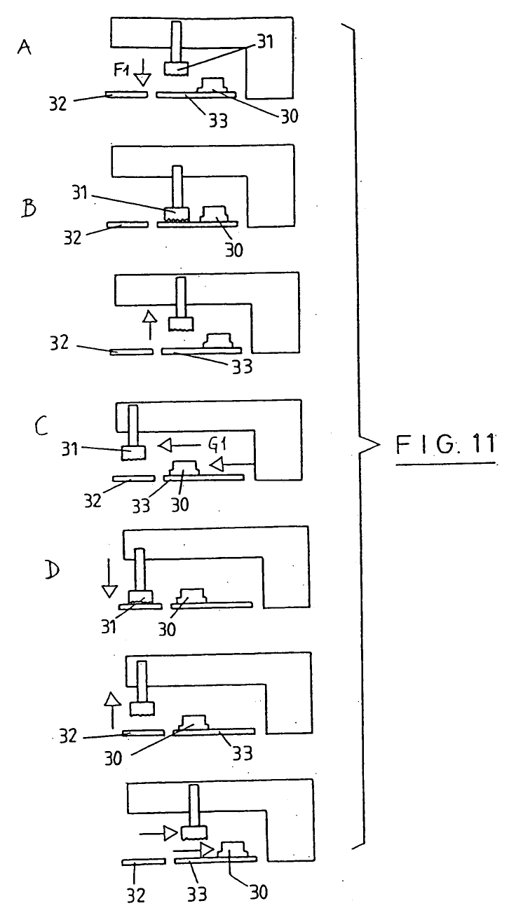

FIGS. 9 and 10 show how a pad rolls over the tablet during the printing phase without slipping.

When depositing the printing image of the pad on the tablets, there is a risk that the tablets keep hanging on the pad due to their low weight and the stickiness of some inks. In order to prevent this, a vacuum chamber is provided under the table plate 14 at the printing position, i.e. directly under the print head, which vacuum chamber holds the tablets 6 during the printing operation through little holes 39 in the table plate 14 as shown in FIG. 8. The needed vacuum can be supplied by an electrical vacuum pump in combination with a vacuum valve which is controlled in such a way that there is a vacuum under the tablets only at the time that the printing operation effectively takes place, and thus not when the tablets are moved. Advantageously, a vacuum block has not to be changed again, but only the upper plate thereof.

The print head 25 is of the linear pad printing type with closed ink pattern. The operation thereof is represented in the lateral view of FIG. 11 where the closed ink pattern 30, the pad 31, the clich 33 and the segment with the tablets 32 are represented. The operation of the tablet conveyor system is set out by means of the diagrammatic representations represented in cross section in FIG. 11.

Position A is the starting position. Starting therefrom the pad 31 is moved downwardly in a substantially vertical moving direction indicated by arrow F1 in order to take up ink from a clich 33. After taking ink in position B, the pad returns back up in position A. In position C, said pad with the transferred image is moved frontward in a substantially horizontal moving direction G1, until above the tablets to be printed in the segment 32. At the same time, the ink pattern 30 slides frontward in order to ink the engraving in the clich 33. The pad 31 is moved downwardly in position D and deposits the transferred image on the tablets after which the pad is moved again upwards in position C. Subsequently the pad 31 moves back to the starting position A and the closed ink pattern 30 is moved back to the starting position.

The ink pattern or the closed little ink pot was described yet in the patent application EP 96200793.6, the teachings of which are considered to be incorporated in this application as a matter of reference. It is to be understood that the operation described above is given only as a matter of example and may in no way be considered as limiting the protection scope of this patent application.

What is claimed is:

1. Printing apparatus for printing relatively small, light objects including medical tablets (6), having a certain brittleness and/or porosity comprising a movable print head (25), a printing liquid tank (30), and a conveyor unit (32) supplying and discharging the objects to be printed (6) to, respectively from the print head (25), wherein the print head (25) is arranged in a linear pad printing system with a closed ink system wherein said printing liquid tank (30) being arranged with said conveyor unit (32) including a rotating table (14, 17) having predetermined locations (24; respectively 24′, 24″) for receiving temporarily the objects (6) during the printing stage.

2. Printing apparatus according to claim 1, wherein said rotating table is comprised of a table plate (14) having a high smoothness whereupon a set of segments (17) is provided which are able to float at a small height (38) over said table plate (14), wherein said table plate and segments are plane.

3. Printing apparatus according to claim 2, wherein said segments (17) are provided with holes (24) which are realized in the segments (17) wherein said objects to be printed (6) fit so that their bottom side can get into contact with said table plate (14).

4. Printing apparatus according to claim 2, wherein said segments (17) are removable and mutually changeable, thereby having holes (24) with different size and shape, which are adapted to the objects to be printed, wherein said holes (24) are arranged according to a predetermined pattern (24′, 24″) in each segment (17).

5. Printing apparatus according to one of the claims 2, wherein said segments (17) are comprised in a disk/(24′, 24″), wherein the segments are mutually adjacent two by two and/or radially separated from each other.

6. Printing apparatus according to claim 2, comprising a supply unit (20) provided wherein the objects (6) to be printed are stocked for being supplied on said rotating table, wherein a set of brushes are arranged in a brush casing (21) which are provided at the outlet aperture of the supply unit (20) and streaming downwardly therefrom, so that they can work as object separators over the segments (17) for a substantially complete occupation of the holes (24) therefrom.

7. Printing apparatus according to claim 6, comprising a blow unit (22) arranged streaming downwardly from the brush casing (21) for blowing away waste objects to a receiving unit (23).

8. Printing apparatus according to claim 1, comprising a drying station (26) provided streaming downwardly from the moveable print head (25) for drying the printed objects (6).

9. Printing apparatus according to claim 2, comprising a vacuum chamber (28) provided under the rotating table (14, 17) at the printing head (25) for holding the objects (6) during the printing operation by means of small holes (39) in the table plate (14) provided therefor.

10. Printing apparatus according to claim 9, wherein said vacuum aperture is arranged substantially centrally respective to the corresponding holes (24) for the objects (6) to be printed.

11. Process for printing objects, in particular medical tablets, comprising a pad printing head (31) that starts from the starting position (A), wherefrom the pad printing head (31) is moved downwardly to take over a quantity of printing liquid, in particular ink, from a plate (33) in an ink take-over position (B), after which the pad printing head (31) loaded with ink is moved upwardly again into position (A), after which the pad printing head (31) with the image take-over is moved forwardly until above the object to be printed (6) in segment (17), wherein the ink tank (30) is also moved simultaneously in the same direction forwardly so as to ink the image in the plate (33) again,
after which the pad printing head (31) is moved downwardly to the object to be printed and deposits thereon the image taken over,
after which the pad printing head is moved again in its initial position (A) just like said ink tank (30).
